(19) United States
(12) Patent Application Publication
(10) Pub. No.: US 2025/0260826 A1
(43) Pub. Date: Aug. 14, 2025

(54) MOTION INFORMATION CANDIDATES RE-ORDERING

(71) Applicant: InterDigital CE Patent Holdings, SAS, Paris (FR)

(72) Inventors: Franck Galpin, Thorigne-Fouillard (FR); Antoine Robert, Mézières sur Couesnon (FR); Guillaume Boisson, Pleumeleuc (FR); Karam Naser, Mouazé (FR)

(73) Assignee: InterDigital CE Patent Holdings, SAS, Paris (FR)

(21) Appl. No.: 18/855,127

(22) PCT Filed: Apr. 7, 2023
(86) PCT No.: PCT/EP2023/059311

§ 371 Date: Oct. 8, 2024

(30) Foreign Application Priority Data
Apr. 8, 2022 (EP) 22305506.2

(51) Int. Cl. H04N 19/139; H04N 19/176

(52) U.S. Cl. CPC H04N 19/139; H04N 19/176

(57) ABSTRACT

Systems, methods, and instrumentalities are disclosed for performing motion information candidates re-ordering. A device may be configured to obtain motion information, for example, comprising motion information candidates. The device may obtain a video block including one or more subblocks. The device may determine a motion model (e.g., global motion model and/or local motion model) associated with a subblock. The device may compute a score associated with a motion information candidate, for example, based on the motion model. The score may be determined based on a determined consistency between the motion model and the motion information candidate. The device may perform refinement on the motion information candidate. The score may be computed based on a refined motion information candidate. The device may determine an order associated with the motion information candidates, for example, based on the scores. The order may be organized from a low score to a high score.

### CROSS-REFERENCE TO RELATED APPLICATIONS

The application claims the benefit of European Patent Application Number 22305506.2, filed Apr. 8, 2022, the contents of which are incorporated by reference in their entirety herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing motion information candidates re-ordering. A device (e.g., video decoding device, video encoding device) may re-order motion information candidates. The device may obtain motion information candidates associated with a block. The device may determine motion information associated with the block (e.g., reference motion information, environment motion information). The motion information may be global motion information, local motion information, neighbor motion information, and/or the like. For example, global motion information may be indicated (e.g., signaled via a slice header) and/or derived (e.g., based on temporal scaling associated with a reference picture). For example, local motion information may be derived based on motion information candidates associated with neighboring blocks of the block. The device may determine an order associated with the motion information candidates, for example, based on comparing respective motion information candidates with the motion information. The device may perform a coding operation (e.g., decoding, encoding) based on the determined order associated with the motion information candidates.

In examples, the device may determine the order of the motion information candidates based on whether a template-based coding tool is enabled for the block. The device may obtain an indication that indicates whether a template-based coding tool is enabled for the block. The device may order the motion information candidates based on a determination that the template-based coding tool is disabled (e.g., not enabled) for the block. The ordering of the motion information candidates may be performed independent from reconstructed template samples (e.g., if the template-based coding tool is disabled for the block).

In examples, to order the motion information candidates, the device may determine consistency value(s) associated with respective motion information candidates (e.g., relative to the obtained motion information). For example, the device may determine a first consistency value associated with a first motion information candidate and determine a second consistency value associated with a second motion information candidate. The device may rank the motion information candidates based on the consistency value. For example, the first motion information candidate may be ranked higher than the second motion information candidate based on a determination that the first motion information candidate is associated with a higher consistency value than the second motion information candidate.

In examples, the device may order the motion information candidates based on a threshold. For example, the device may determine a difference between a first motion information candidate and a second motion information candidate. The device may determine that the difference between the first motion information candidate and the second motion information candidate is below the threshold. The device may (e.g., based on the determination that the difference is below the threshold), remove the second motion information candidate (e.g., because it is too similar to the first motion information candidate).

A device may be configured to obtain motion information, for example, comprising motion information candidates. The device may obtain a video block including one or more subblocks. The device may determine a motion model (e.g., global motion model and/or local motion model) associated with a subblock. The device may compute a score associated with a motion information candidate, for example, based on the motion model. The score may be determined based on a determined consistency between the motion model and the motion information candidate. The device may perform refinement on the motion information candidate. The score may be computed based on a refined motion information candidate. The device may determine an order associated with the motion information candidates, for example, based on the scores. The order may be organized from a low score to a high score.

The device may obtain a video block comprising subblocks. The device may determine to use a motion model associated with a subblock. The motion model may be a global motion model and/or a local motion model. The device may determine motion information associated with the subblock using the determined motion model. The motion information may include motion information candidates. The device may generate a bitstream including an indication indicating the motion information and the determine motion model. The bitstream may include an indication indicating global motion model parameters (e.g., if the motion model is a global motion model).

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples may be implemented.

FIG. 5 illustrates an example decoding pipeline of an inter block.

FIG. 6 illustrates an example template matching based decoding pipeline.

FIG. 7 illustrates an example control point based affine motion model.

FIG. 8 illustrates an example affine motion vector per subblock.

FIG. 9 illustrates an example location of inherited affine motion predictors.

FIG. 10 illustrates an example control point motion vector inheritance.

FIG. 11 illustrates an example of locations of candidates position for constructed affine merge mode.

FIG. 12 illustrates example positions of spatial and temporal motion vector predictors used in the merge mode.

FIG. 13 illustrates example motion scaling for a temporal merge candidate.

FIG. 14 illustrates an example subblock-based temporal motion vector prediction (SbTMVP) process.

FIG. 15 illustrates an example of template matching performing on a search area around an initial MV.

FIG. 16 illustrates an example of diamond regions in a search area.

FIG. 17 illustrates example template and reference samples of the template in reference pictures.

FIG. 18 illustrates example template and reference samples of the template for a block with sub-block motion using the motion information of the subblocks of the current block.

FIG. 19 illustrates an example of spatial neighboring blocks used to derive the spatial merge candidates.

FIG. 20 illustrates an example symmetrical motion vector difference mode.

FIG. 21 illustrates an example local motion model computation.

FIG. 22 illustrates an example temporal buffer construction.

FIG. 23 illustrates an example symmetrical temporal candidate process.

FIG. 24 illustrates example motion candidate consistency.

### DETAILED DESCRIPTION

A more detailed understanding may be had from the following description, given by way of example in conjunction with the accompanying drawings.

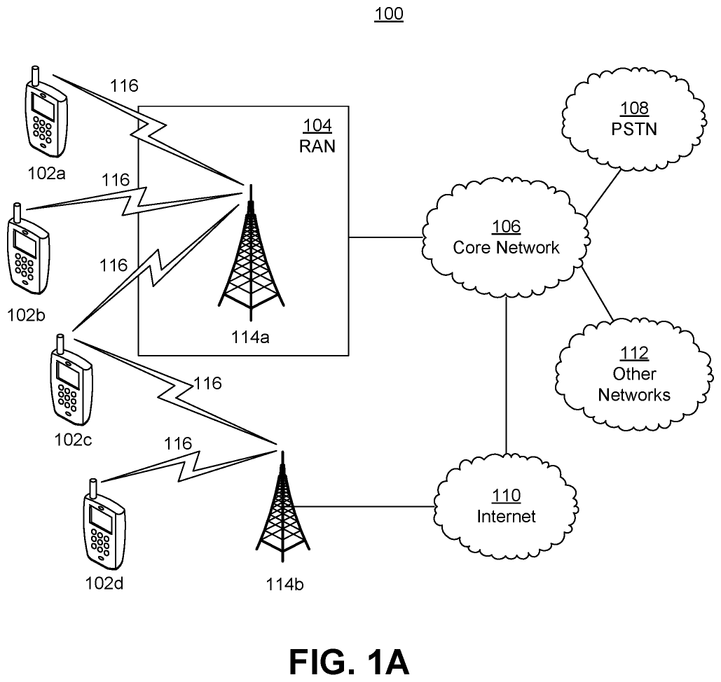

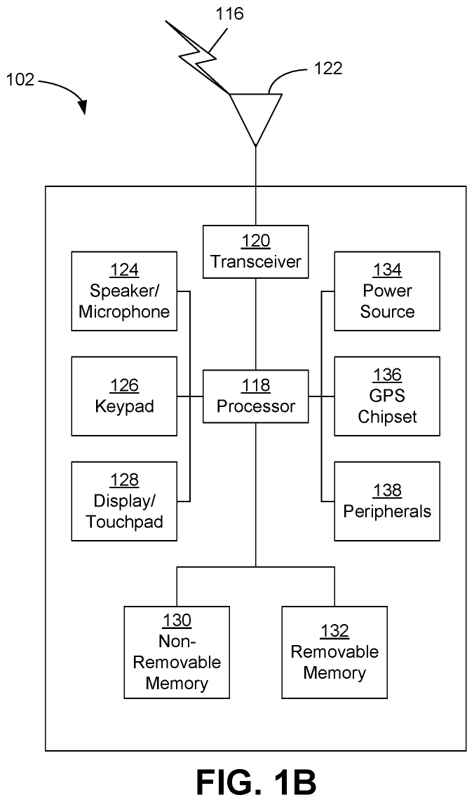

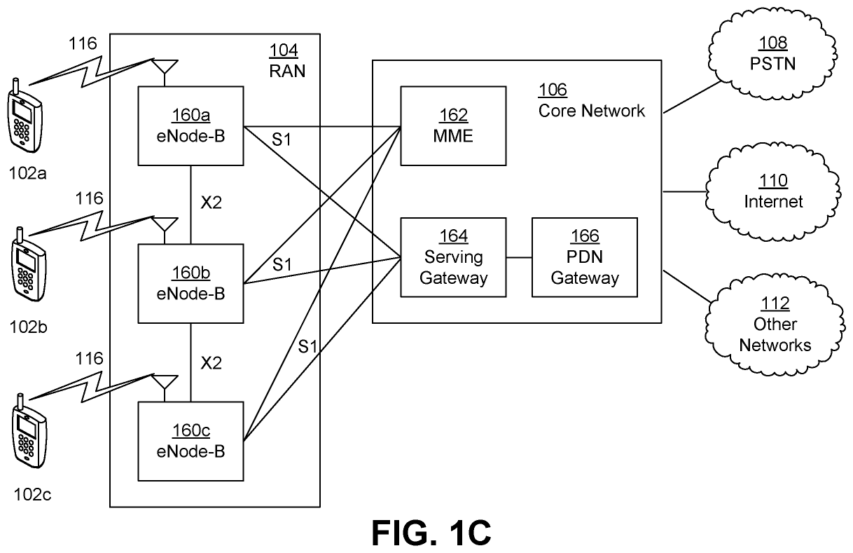

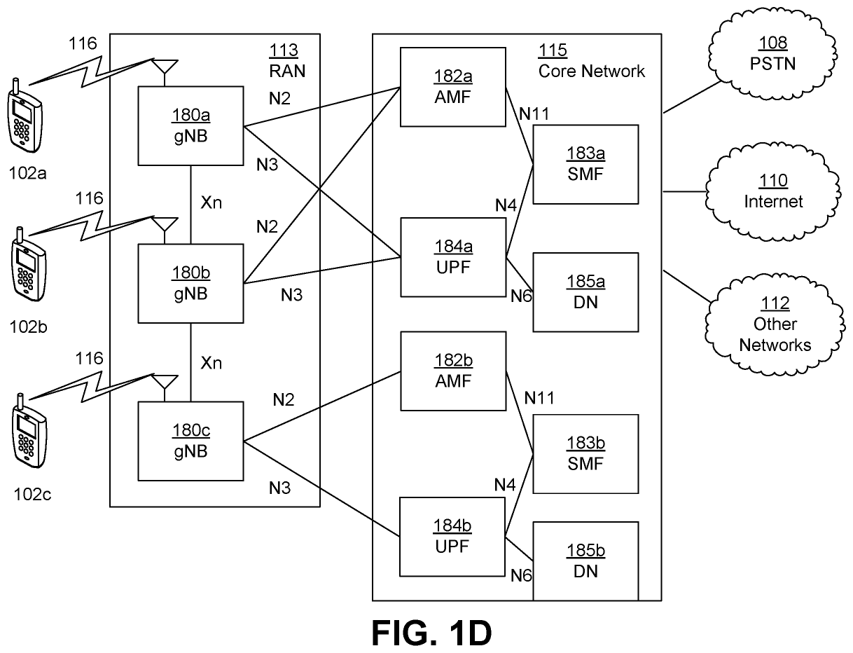

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

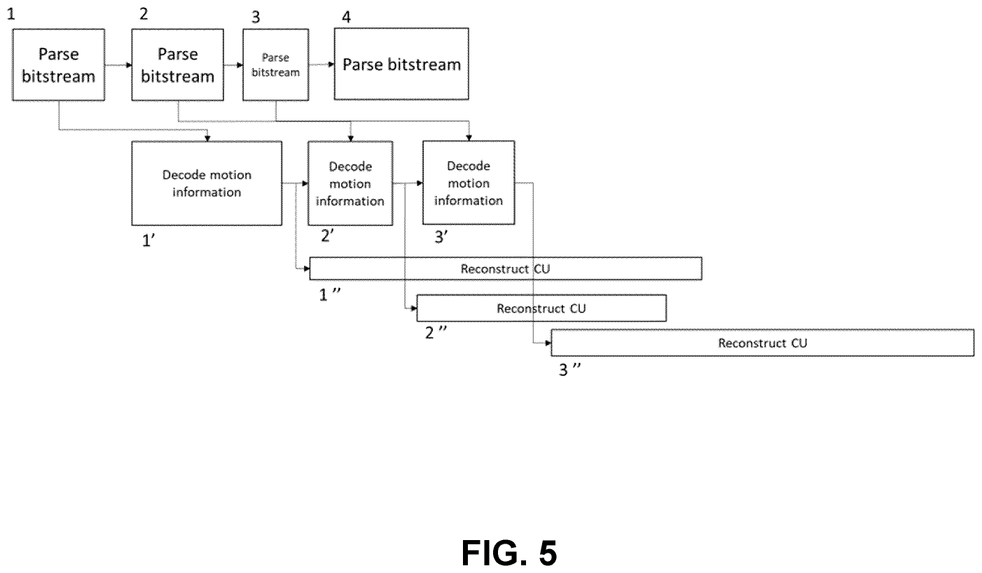

The aspects described and contemplated in this application may be implemented in many different forms. FIGS. 5-24 described herein may provide some examples, but other examples are contemplated. The discussion of FIGS. 5-24 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

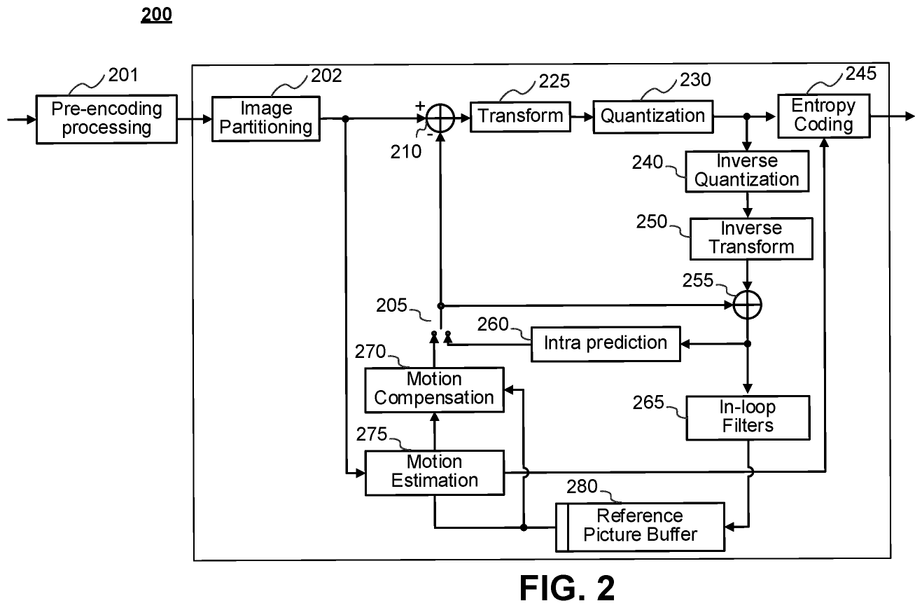

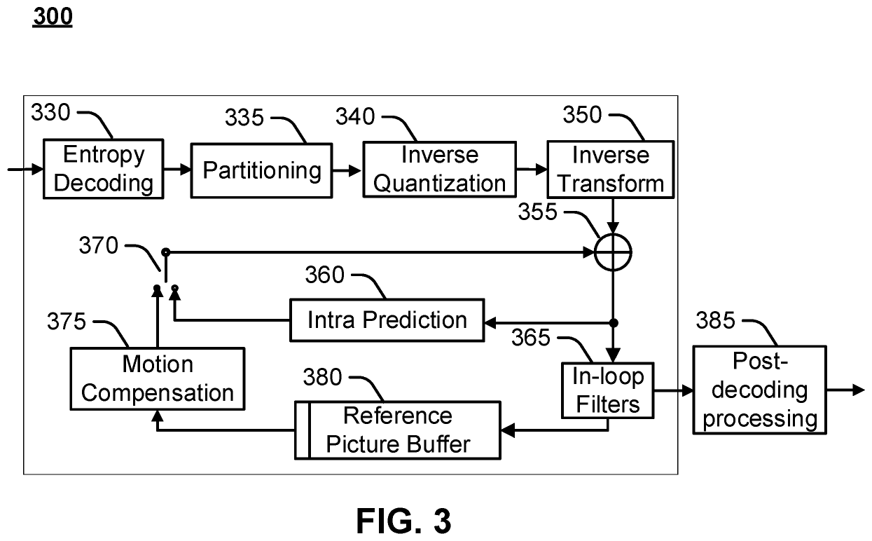

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

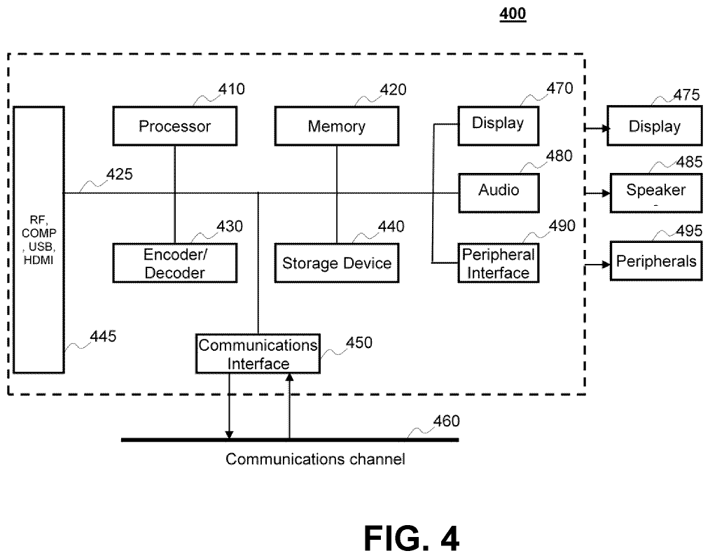

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth© network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, obtaining motion information (e.g., motion information candidates), determining a motion model associated with a first subblock, computing a score associated with a motion information candidate (e.g., based on a motion model), determining an order associated with motion information candidates based on the scores, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining to use a motion model associated with a subblock, determining motion information associated with a subblock using the determined motion model (e.g., where the motion information includes motion information candidates), indicate the motion information and the determined motion model, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, motion information (e.g., motion information candidates), motion models, motion model parameters, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

In an inter or intra frame, the reconstruction of a block may be split into stages (e.g., several stages), such as, for example, one or more of the following: the mode decoding (e.g., prediction type, transform type etc.), the prediction itself, the residual decoding (e.g., if any), and/or block reconstruction (e.g., the final block reconstruction). For example (e.g., for an inter block), the encoder may select a block (e.g., the best block) in a reference frame, e.g., after applying a motion model (e.g., translational or sub-block based motion).

FIG. 5 illustrates an example decoding pipeline of an inter block. An example decoding pipeline of an inter block may involve processing stages and the dependencies between the processing stages (e.g., as shown in FIG. 5). As shown, a box may correspond to a particular block. The width of the block may emphasize the duration of the process.

For example, parsing of the syntax of block 1 may be performed (e.g., as shown in FIG. 5 at (1)). The decoding of the information may be performed (e.g., as shown in FIG. 5 at (1′)), for example, after the parsing. Parsing of a block may be performed in parallel, for example, during this stage.

Reconstruction of the block may be performed (e.g., as shown in FIG. 5 at (1″)), for example, after decoding. Reconstruction of block 2 (e.g., as shown in FIG. 5 at (2″)) may be performed (e.g., as soon as the decoding is finished as shown in FIG. 5 at (2′)), for example, because of the dependencies between reconstruction of blocks.

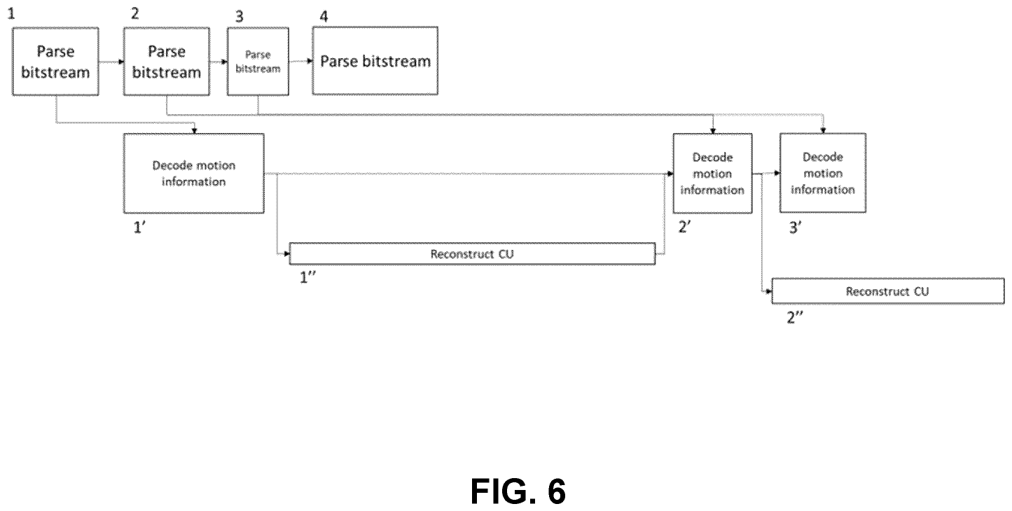

Operations involving a template around a current block to infer or reduce the signaling cost may be performed, for example, such as TM or ARMC-TM (e.g., as described herein). FIG. 6 illustrates an example TM based decoding pipeline. As shown, changes on the decoding pipeline may be provided. Reconstruction of the blocks may be refrained from being performed (e.g., not be performed) in parallel (e.g., as shown in FIG. 6), for example, if there is a dependency between the reconstruction of block 1 and the decoding of block 2. The constraint may put a burden (e.g., heavy burden) on the decoder (e.g., which may not parallelize anymore the most computationally heavy stages (e.g., reconstruction)).

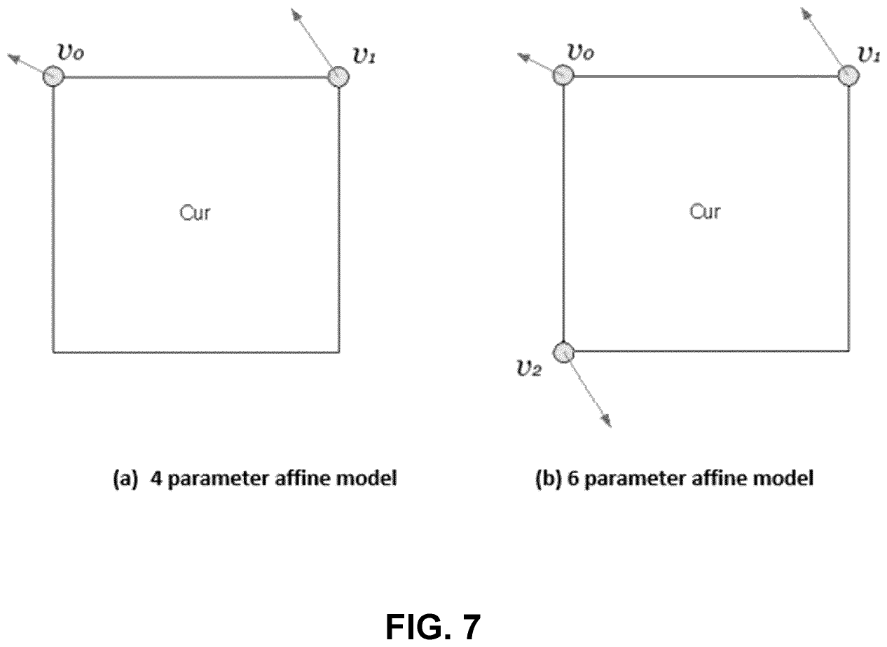

Affine motion compensated prediction may be performed. A translation motion model (e.g., only a translational motion model) may be applied for motion compensation prediction (MCP). In the real world, motion may include and/or refer to, for example zoom in/out, rotation, perspective motions, and/or other irregular motions. A block-based affine transform motion compensation prediction may be applied. FIG. 7 illustrates an example control point based affine motion model. As shown, the affine motion field of the block may be described by motion information of multiple control point motion vectors, for example, such as two control point (e.g., 4-parameter) or three control point motion vectors (e.g., 6-parameter).

For a 4-parameter affine motion model, a motion vector at sample location (x, y) in a block may be derived according to Eq. 1.

$$\{ \begin{matrix}m {v}_{x} = \frac{m {v}_{1 x} - {mv}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad Eq . 1$$

For a 6-parameter affine motion model, a motion vector at sample location (x, y) in a block may be derived according to Eq. 2.

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad Eq . 2$$

where (mv0x, mv0y) may be a motion vector of the top-left corner control point, (mv1x, mv1y) may be a motion vector of the top-right corner control point, and (mv2x, mv2y) may be motion vector of the bottom-left corner control point.

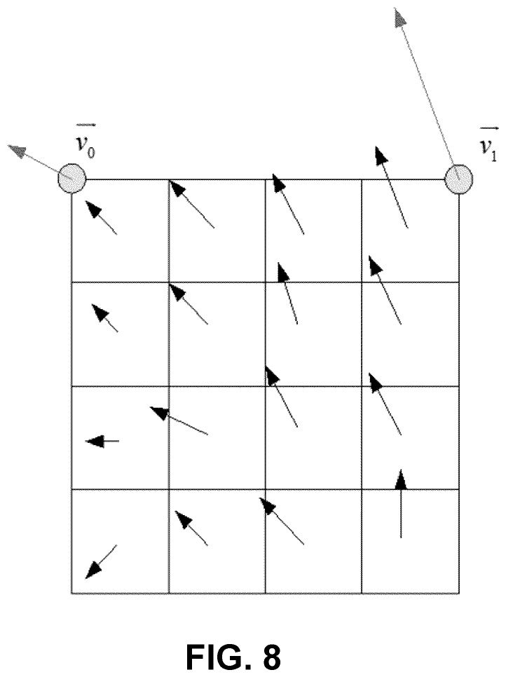

Block based affine transform prediction is applied, for example, to simplify the motion compensation prediction. FIG. 8 illustrates an example affine MVF per subblock. The motion vector of the center sample of a (e.g., each) subblock (e.g., as shown in FIG. 8) may be calculated (e.g., according to Eqs. 1 and 2) and may be rounded (e.g., to 1/16 fraction accuracy), for example, to derive motion vector of a (e.g., each) 4×4 luma subblock. The motion compensation interpolation filters may be applied to generate the prediction of a (e.g., each) subblock with a derived motion vector. The subblock size of chroma-components may be set to be 4×4. The MV of a 4×4 chroma subblock may be calculated as the average of the MVs of the top-left and bottom-right luma subblocks in the collocated 8×8 luma region.

As done for translational motion inter prediction, affine motion inter prediction modes may include affine merge mode and/or affine AMVP mode.

Affine merge prediction may be performed. AF_MERGE mode can be applied for CUs, for example, with both width and height larger than or equal to 8. In AF_MERGE mode, the CPMVs of the current CU may be generated, for example, based on the motion information (e.g., of the spatial neighboring CUs). Multiple CPMVP candidates may be provided (e.g., there can be up to five motion model candidates). An index may be signaled, for example, to indicate a motion model candidate to be used for the current CU. The affine merge candidate list may be formed by one or more of the following motion model candidate types: inherited affine merge candidates that extrapolated from the CPMVs of the neighbor CUs; constructed affine merge candidates CPMVPs that are derived using the translational MVs of the neighbor CUs; zero MVs; etc.

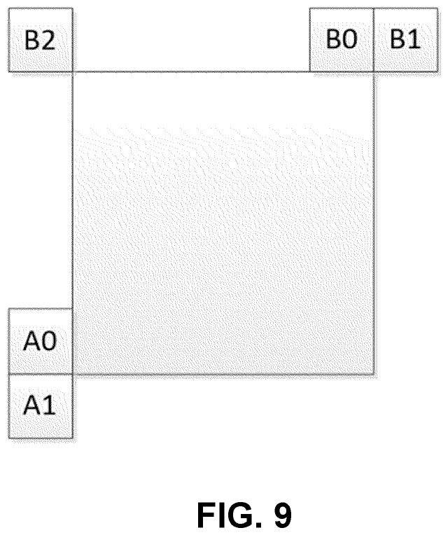

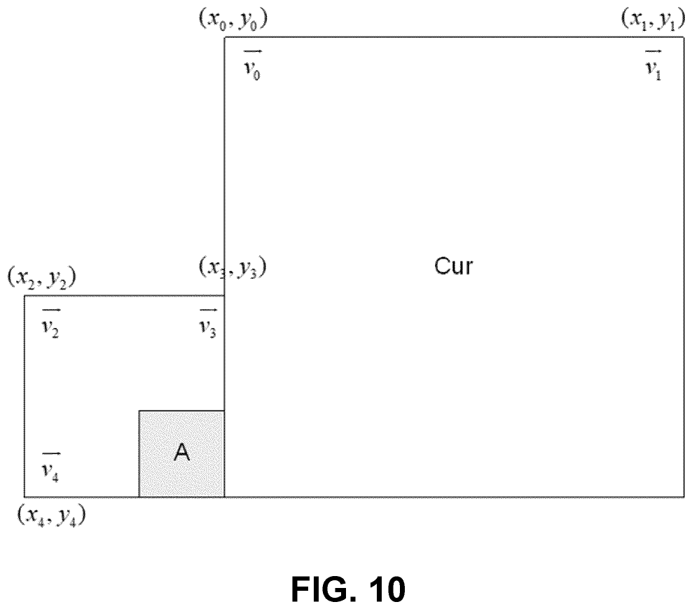

Multiple (e.g., maximum two) inherited affine candidates may be derived from affine motion model of the neighboring blocks, for example, one from left neighboring CUs and one from above neighboring CUs. FIG. 9 illustrates an example location of inherited affine motion predictors. The candidate blocks are shown in FIG. 9. For the left predictor, the scan order may be A0→A1. For the above predictor, the scan order may be B0→B1→B2. The first inherited candidate (e.g., only the first inherited candidate) from a (e.g., each) side may be selected. A pruning check between multiple (e.g., two) inherited candidates may be skipped (e.g., no pruning check is performed). If (e.g., when) a neighboring affine CU is identified, its control point motion vectors may be used to derive the CPMVP candidate in the affine merge list of the current CU. FIG. 10 illustrates an example control point motion vector inheritance. As shown in FIG. 10, the motion vectors v_2, v_3 and v_4 of the top left corner and the motion vectors above right corner and left bottom corner of the CU (e.g., which contains the block A), may be attained, for example, if the neighbor left bottom block A is coded in affine mode. The multiple (e.g., two) CPMVs of the current CU may be calculated according to v_2, and v_3, for example, if (e.g., when) block A is coded with a 4-parameter affine model. The multiple (e.g., three) CPMVs of the current CU may be calculated according to v_2, v_3 and v_4, for example, if block A is coded with a 6-parameter affine model.

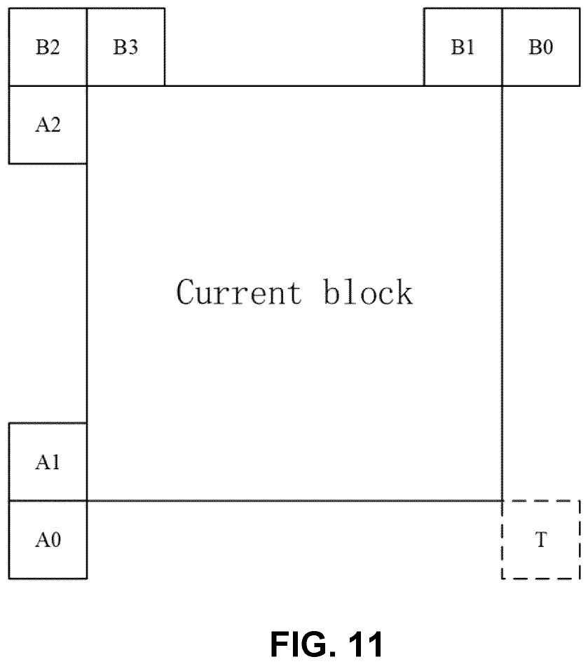

A constructed affine candidate may include a candidate that is constructed by combining the neighbor translational motion information of a (e.g., each) control point. FIG. 11 illustrates an example of locations of candidates position for constructed affine merge mode. The motion information for the control points may be derived from the specified spatial neighbors and temporal neighbor (e.g., as shown in FIG. 11). CPMVk (k=1, 2, 3, 4) may represent the k-th control point. For CPMV1, the B2→B3→A2 blocks may be checked and the MV of the (e.g., first) available block may be used. For CPMV2, the B1→B0 blocks may be checked. For CPMV3, the A1→A0 blocks may be checked. TMVP may be used as CPMV4, for example, depending on availability (e.g., if TMVP is available).

After MVs of multiple (e.g., four) control points are attained, affine merge candidates may be constructed based on the motion information (e.g., the control points). The (e.g., combination of) control point MVs may be used to construct the following: {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of multiple (e.g., three) CPMVs may construct a 6-parameter affine merge candidate. The combination of multiple (e.g., two) CPMVs may construct a 4-parameter affine merge candidate. The related combination of control point MVs may be discarded (e.g., to avoid motion scaling process), for example, if the reference indices of control points are different.

Zero MVs may be inserted to the end of the list (e.g., after inherited affine merge candidates and constructed affine merge candidate are checked), for example, if the list is not full.

Temporal motion vector prediction may be applied and/or provided.

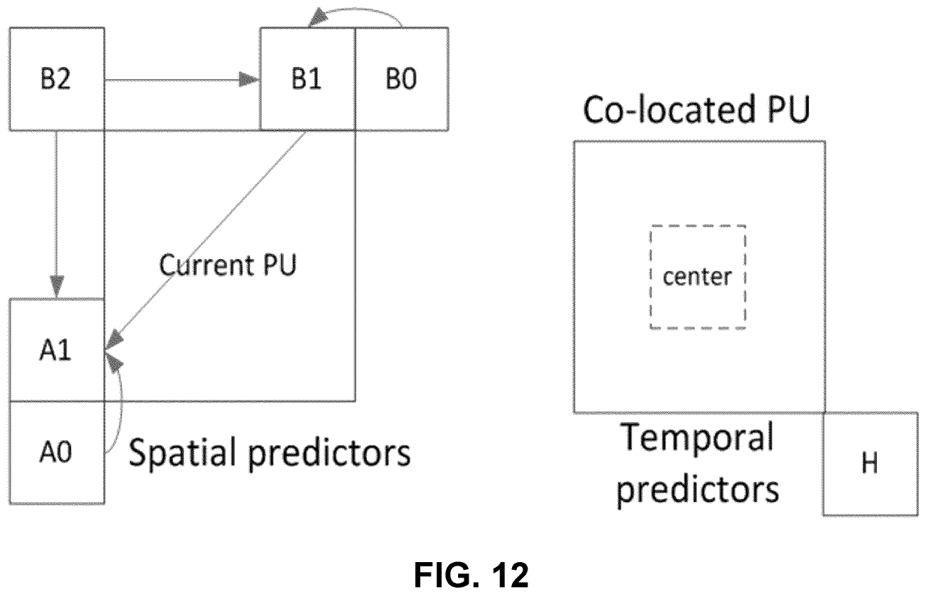

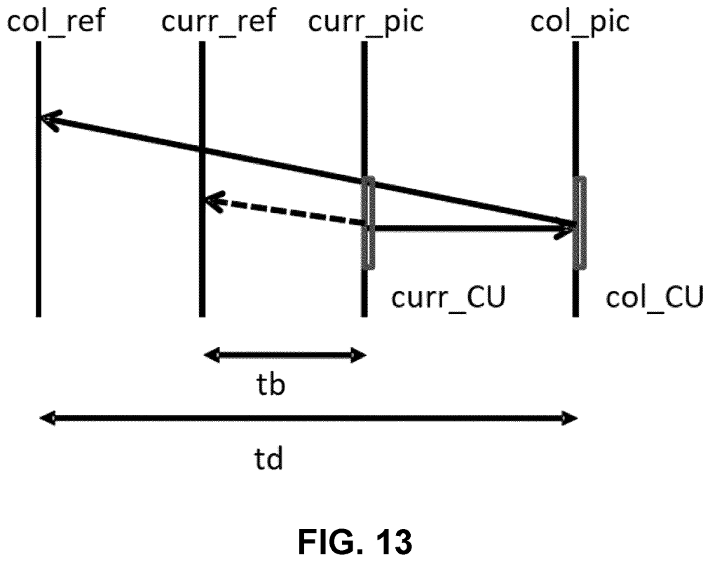

FIG. 12 illustrates example positions of spatial and temporal motion vector predictors used in the merge mode. Spatial merge candidates are shown on the left in FIG. 12. Temporal merge candidates are shown on the right in FIG. 12. In regular merge, TMVP may use a collocated motion vector H in the bottom right corner of the considered block (or C the center position in the considered block is not available), for example, as shown in FIG. 12. The collocated motion vector may be the motion vector in the collocated reference picture (e.g., a reference picture in the reference picture buffer signaled at slice level), collocated at position H or C. The motion vector may be rescaled to use the first reference picture in the reference picture buffer of the L0 or L1 list. FIG. 13 illustrates example motion scaling for a temporal merge candidate. As shown in FIG. 13, Curr_pic may be the current picture, Col_pic may be the collocated picture, Col_ref may be the reference picture used by the motion vector in Col_pic, and Curr_ref may be the reference picture used by the current block in curr_pic. The scaling process may be illustrated in FIG. 13.

Subblock-based temporal motion vector prediction (SbTMVP) may be applied and/or provided.

The subblock-based temporal motion vector prediction (SbTMVP) operation may be supported. SbTMVP may use the motion field in the collocated picture to improve motion vector prediction and merge mode for CUs in the current picture (e.g., similar to the temporal motion vector prediction (TMVP)). The collocated picture (e.g., same collocated picture) used by TMVP may be used for SbTMVP. SbTMVP may differs from TMVP in one or more of the following aspects: TMVP may predict motion at CU level and SbTMVP may predict motion at a sub-CU level; TMVP may fetch the temporal motion vectors from the collocated block in the collocated picture (e.g., the collocated block is the bottom-right or center block relative to the current CU), and SbTMVP may apply a motion shift before fetching the temporal motion information from the collocated picture (e.g., where the motion shift is obtained from the motion vector from one of the spatial neighboring blocks of the current CU).

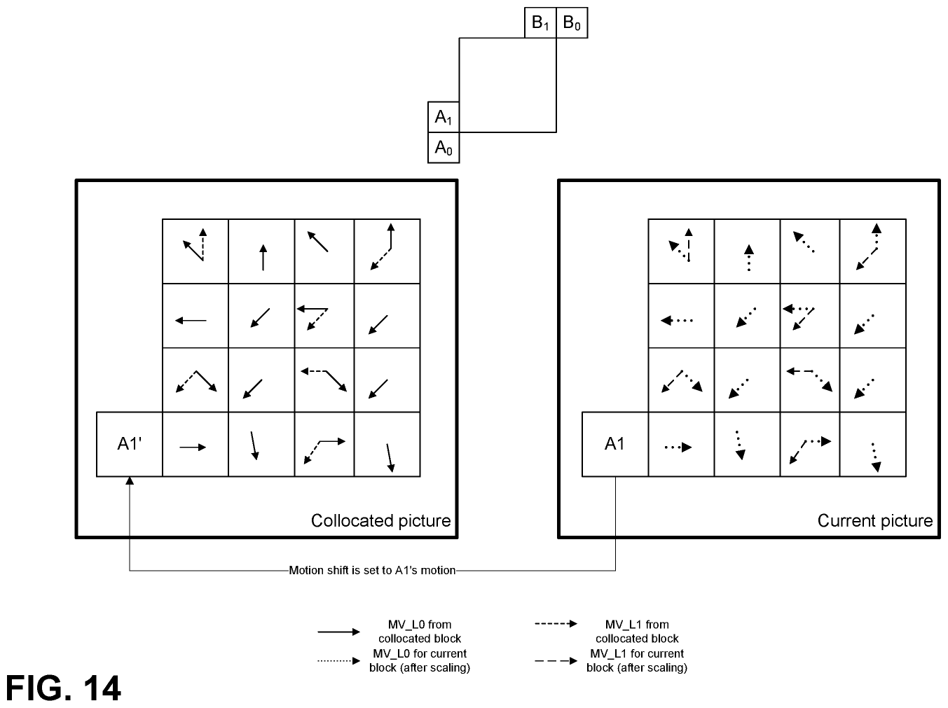

FIG. 14 illustrates an example SbTMVP process. SbTMVP may predict the motion vectors of the sub-CUs, for example, within the current CU (e.g., in multiple (e.g., two) steps). The spatial neighbor A1 (e.g., as shown in FIG. 14(a)) may be examined, for example, in a (e.g., first) step. If A1 has a motion vector that uses the collocated picture as its reference picture, this motion vector may be selected to be the motion shift to be applied. If no such motion is identified, then the motion shift may be set to (0, 0).

A motion shift (e.g., the motion shift identified in a first step as described herein) may be applied (e.g., added to the current block's coordinates) to obtain sub-CU level motion information (e.g., motion vectors and reference indices) from the collocated picture (e.g., as shown in FIG. 14(b)), for example, in a e.g., (second) step. The motion shift may be assumed to be set to block A1's motion (e.g., as shown in FIG. 14(b)). The motion information of a (e.g., each) sub-CU corresponding block (e.g., the smallest motion grid that covers the center sample) in the collocated picture may be used to derive the motion information for the sub-CU, for example, for a (e.g., each) sub-CU. After the motion information of the collocated sub-CU is identified, the motion information may be converted to the motion vectors and reference indices of the current sub-CU (e.g., in a similar way as the TMVP process), for example, where temporal motion scaling may be applied to align the reference pictures of the temporal motion vectors to those of the current CU.

FIG. 14 at (a) illustrates spatial neighboring blocks used by SbTMVP. FIG. 14 at (b) illustrates deriving sub-CU motion field by applying a motion shift from spatial neighbor and scaling the motion information from the corresponding collocated sub-CUs.

A combined subblock based merge list (e.g., which may contain both SbTMVP candidate and affine merge candidates) may be used for the signaling of a subblock based merge mode. The SbTMVP mode may be enabled or disabled, for example, by a flag (e.g., sequence parameter set (SPS) flag). The SbTMVP predictor may be added as an entry (e.g., the first entry) of the list of subblock based merge candidates (e.g., and followed by the affine merge candidates), for example, if the SbTMVP mode is enabled. The size of subblock based merge list may be signaled in SPS. The allowed size (e.g., maximum allowed size) of the subblock based merge list may be 5.

The sub-CU size used in SbTMVP may be fixed to be 8×8. SbTMVP mode may be applicable (e.g., only applicable) to the CU with both width and height are larger than or equal to 8 (e.g., as done for affine merge mode).

The encoding logic of the additional SbTMVP merge candidate may be similar and/or the same as for the other merge candidates (e.g., for a (e.g., each) CU in P or B slice, an additional RD check may be performed to decide whether to use the SbTMVP candidate).

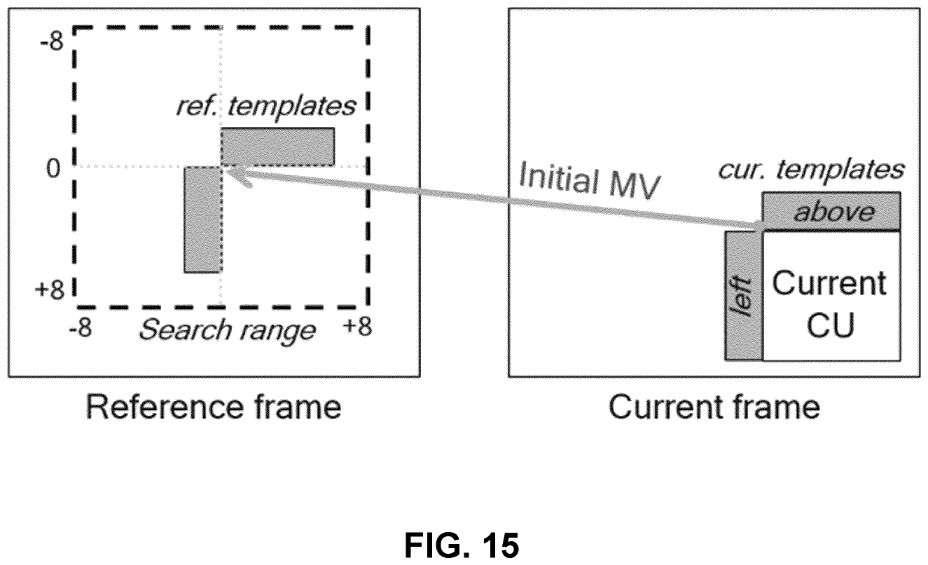

Template matching may be performed and/or provided. Template matching (TM) may be a derivation operation (e.g., a motion vector (MV) derivation operation, a decoder-side MV derivation operation). TM may enable refining motion information of a CU (e.g., the current CU), for example, by finding a match (e.g., the closest match) between a template (e.g., top and/or left neighboring blocks of the current CU) in a picture (e.g., the current picture) and a block (e.g., same size to the template) in a reference picture. FIG. 15 illustrates an example of template matching performing on a search area around an initial MV. As illustrated in FIG. 15, an MV (e.g., better MV) is searched around the initial motion of the current CU within a [−8, +8]-pel search range. The template matching method may be used with one or more of the following modifications: search step size is determined based on an adaptive motion vector resolution refinement (AMVR) mode; and/or TM can be cascaded with a bilateral matching process in merge modes.

In AMVP (advanced motion vector prediction) mode, a motion vector predictor (MVP) candidate may be determined, for example, based on a template matching error. A template matching error may include an error in selecting an MVP candidate which reaches a difference (e.g., minimum difference) between the current block template and the reference block template, and then TM is performed only for the selected MVP candidate (e.g., particular MVP candidate) for MV refinement. TM may refine this MVP candidate, for example, starting from full-pel motion vector difference (MVD) precision or 4-pel for 4-pel AMVR mode within a [−8, +8]-pel search range (e.g., by using iterative diamond search). The AMVP candidate may be further refined, for example, by using a cross search with full-pel MVD precision or 4-pel for 4-pel AMVR mode, followed sequentially by half-pel and quarter-pel ones depending on AMVR mode (e.g., as shown in Table 1). This search process may ensure that the MVP candidate keeps the same MV precision (e.g., as indicated by the AMVR mode) after the TM process. In the search process, the search process may terminate, for example, if the difference between the previous minimum cost and the current minimum cost in the interaction is less than a threshold that is equal to the area of the block.

TABLE 1
Search patterns of AMVR and merge mode with AMVR.

| | AMVR mode | | | | Merge mode | |
|---|---|---|---|---|---|---|
| Search pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, a search operation may be applied to the merge candidate (e.g., merge candidate indicated by the merge index). As shown in Table 1, TM may perform precision down to ⅛-pel MVP precision (e.g., all the way down to ⅛-pel MVD precision) or skipping those beyond half-pel MVD precision, for example, depending on whether the alternative interpolation filter (e.g., that is used when AMVR is using half-pel mode) is used according to merged motion information. TM may work as an independent process and/or an extra MV refinement process, for example, between block-based and subblock-based bilateral matching (BM) operations. Template matching may work as an independent process or an extra MV refinement process between block-based and subblock-based bilateral matching (BM) methods (e.g., if/when TM mode is enabled), for example, depending on whether BM can be enabled or not (e.g., according to its enabling condition check).

Multi-pass motion vector refinement may be performed and/or provided. Multi-pass decoder-side motion vector refinement may be performed and/or provided.

A multi-pass vector refinement (e.g., a multi-pass decoder-side motion vector refinement) may be applied. In a first pass, bilateral matching (BM) may be applied to the coding block. In a second pass, BM may be applied to a (e.g., each) subblock (e.g., 16×16 subblock) within the coding block. In a third pass, a MV in a (e.g., each) subblock (e.g., 8×8 subblock) may be refined, for example, by applying bi-directional optical flow (BDOF). The refined MVs may be stored for spatial and/or temporal motion vector prediction.

In a first pass, block based bilateral matching MV refinement may be applied. In the first pass, a refined MV may be derived by applying BM to a coding block. Similar to motion vector refinement (e.g., such as decoder-side motion vector refinement (DMVR)), in bi-prediction operation, a refined MV may be searched around the (e.g., two) initial MVs (e.g., MV0 and MV1) in the reference picture lists L0 and L1. The refined MVs (e.g., MV0_pass1 and MV1_pass1) may be derived around the initial MVs, for example, based on a bilateral matching cost (e.g., the minimum bilateral matching cost) between the (e.g., two) reference blocks in L0 and L1.

BM may include performing a search (e.g., local search) to derive integer sample precision intDeltaMV. The local search may apply a search pattern (e.g., 3×3 square search pattern), for example, to loop through the search range [−sHor, sHor] in horizontal direction and [−sVer, sVer] in vertical direction. The values of sHor and sVer may be determined (e.g., by the block dimension). The maximum value of sHor and sVer may be 8.

The bilateral matching cost may best calculated, for example, as bilCost=mvDistanceCost+sadCost. A MRSAD cost function may be applied to remove the DC effect of distortion between reference blocks, for example, if (e.g., when) the block size cbW*cbH is greater than 64. The intDeltaMV local search may be terminated, for example, if (e.g., when) the bilCost at the center point of the 3×3 search pattern has a specified cost (e.g., the minimum cost). The current minimum cost search point may become a second center point (e.g., the new center point) of the 3×3 search pattern and continue to search for the minimum cost, for example, until it reaches the end of the search range.

The existing fractional sample refinement may be further applied, for example, to derive the final deltaMV. The refined MVs after the first pass may be derived based on Eqs. 1 and 2.

$$MV 0 \_pass 1 = MV 0 + deltaMV \qquad Eq . 3$$

$$MV 1 \_pass 1 = MV 1 - deltaMV \qquad Eq . 4$$

Subblock based bilateral matching MV refinement may be applied, for example, in the second pass. A refined MV may be derived (e.g., in the second pass), for example, by applying BM to a subblock (e.g., 16×16 grid subblock). For a subblock (e.g., each subblock), a refined MV may be searched around the (e.g., two) MVs (e.g., MV0_pass1 and MV1_pass1), which may be obtained on the first pass, in the reference picture lists L0 and L1. The refined MVs (e.g., MV0_pass2(sbldx2) and MV1_pass2(sbldx2)) may be derived based on a bilateral matching cost (e.g., the minimum bilateral matching cost) between the two reference subblocks in L0 and L1.

For a subblock (e.g., each subblock), BM may include performing a search (e.g., full search) to derive integer sample precision intDeltaMV. The full search may have a search range [−sHor, sHor] in horizontal direction and [−sVer, sVer] in vertical direction. The values of sHor and sVer may be determined by the block dimension. The maximum value of sHor and sVer may be 8.

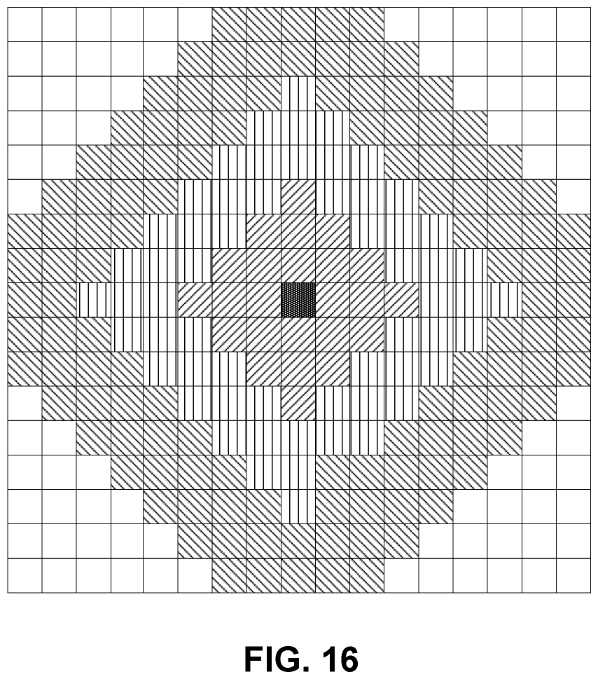

The bilateral matching cost may be calculated by applying a cost factor to the SATD cost between (e.g., two) reference subblocks, for example, as: bilCost=satdCost*costFactor. FIG. 16 illustrates an example of diamond regions in a search area. The search area (2*sHor+1)*(2*sVer+1) may be divided (e.g., in up to five) diamond shape search regions (e.g., as shown in FIG. 16). A search region (e.g., each search region) may be assigned a costFactor. The costFactor may be determined by the distance (e.g., intDeltaMV) between a (e.g., each) search point and the starting MV. A diamond region (e.g., each diamond region) may be processed, for example, in the order starting from the center of the search area. In a (e.g., each) region, the search point(s) may be processed in the raster scan order, for example, starting from the top left going to the bottom right corner of the region. The int-pel full search may be terminated, for example, if (e.g., when) the minimum bilCost within the current search region is less than a threshold (e.g., threshold equal to sbW*sbH). Otherwise, the int-pel full search may continue to the next search region, for example, until the (e.g., all) search points are examined. The search process may terminate, for example, if the difference between the previous minimum cost and the current minimum cost in the iteration is less than a threshold that is equal to the area of the block.

DMVR fractional sample refinement may be further applied to derive the final deltaMV(sbldx2). The refined MVs at second pass may be derived based on Eqs. 3 and 4.

$$MV 0 \_pass 2 ( sbldx 2 ) = MV 0 \_pass 1 + deltaMV ( sbldx 2 ) \qquad Eq . 5$$

$$MV 1 \_pass 2 ( sbldx 2 ) = MV 1 \_pass 1 + deltaMV ( sbldx 2 ) \qquad Eq . 6$$

A subblock based MV refinement (e.g., bi-directional optical flow MV refinement) may be applied, for example, in the third pass. In the third pass, a refined MV may be derived by applying bi-directional optical flow (BDOF) to a subblock (e.g., an 8×8 grid subblock). For a (e.g., each) subblock (e.g., 8×8 subblock), BDOF refinement may be applied to derive a scaled Vx and Vy, for example, without clipping (e.g., starting from the refined MV of the parent subblock of the second pass). The derived bioMv(Vx, Vy) may be rounded (e.g., to 1/16 sample precision) and clipped (e.g., between −32 and 32).

The refined MVs (MV0_pass3(sbldx3) and MV1_pass3(sbldx3)) at third pass may be derived using Eqs. 5 and 6.

$$MV 0 \_pass3 ( sbldx 3 ) = MV 0 \_pass 2 ( sbldx 2 ) + bioMv \qquad Eq . 7$$

$$MV 1 \_pass3 ( sbldx 3 ) = MV 0 \_pass 2 ( sbldx 2 ) - bioMv \qquad Eq . 8$$

Adaptive motion vector refinement (e.g., decoder-side motion vector refinement) may be performed. An adaptive motion vector refinement operation (e.g., adaptive decoder side motion vector refinement operation) may be an extension of a multi-pass DMVR which may include of the (e.g., two new) merge modes to refine MV in a direction (e.g., only in one direction, such as, for example, either L0 or L1) of the bi prediction for the merge candidates (e.g., that meet the DMVR conditions). The multi-pass DMVR process may be applied for the selected merge candidate, for example, to refine the motion vectors. Either MVD0 or MVD1 may be set to zero in the first pass (e.g., PU level) DMVR.

The merge candidates for the (e.g., new) merge mode may be derived from spatial neighboring coded blocks, TMVPs, non-adjacent blocks, history-based motion vector predictors (HMVPs), pair-wise candidate, etc. (e.g., similar as in the regular merge mode). The merge candidates that are determined to meet DMVR conditions may be added into the candidate list. The same merge candidate list may be used by the (e.g., two new) merge modes. Merge index may be coded as in regular merge mode.

Adaptive reordering of merge candidates with template matching (ARMC-TM) may be performed. The merge candidate(s) may be adaptively reordered, for example, with template matching (TM). The reordering operation may be applied to one or more merge modes, for example, such as, regular merge mode, template matching (TM) merge mode, and/or affine merge mode (e.g., which may exclude the SbTMVP candidate). Merge candidates may be reordered before the refinement process, for example, for the TM merge mode.

Merge candidates may be divided into subgroups, for example, after a merge candidate list is constructed. The subgroup size may be set. The subgroup size may be set for regular merge mode and TM merge mode (e.g., set to 5 for regular merge mode and TM merge mode). The subgroup size is set for affine merge mode (e.g., set to 3 for affine merge mode). Merge candidates in a (e.g., each) subgroup may be reordered, for example, ascendingly according to cost values (e.g., based on template matching). Merge candidates in the last but not the first subgroup may be refrained from being reordered (e.g., may not be reordered), for example, for simplification.

The template matching cost of a merge candidate may be measured, for example, by the sum of absolute differences (SAD) between samples of a template of the current block and their corresponding reference samples. The template may comprise a set of reconstructed samples neighboring to the current block. Reference samples of the template may be located by the motion information of the merge candidate.

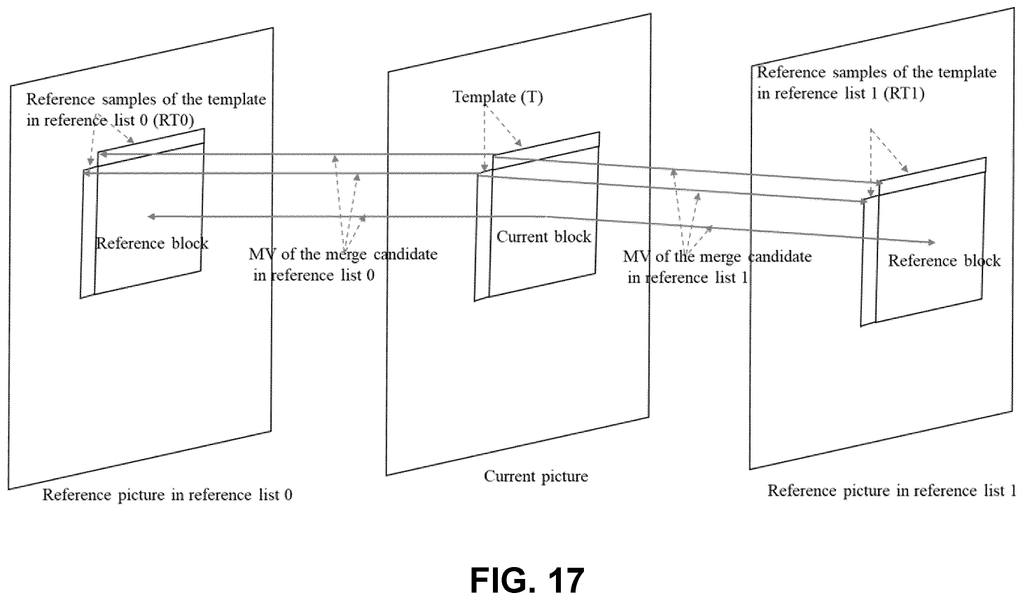

FIG. 17 illustrates example template and reference samples of the template in reference pictures. The reference samples of the template of the merge candidate may be (e.g., additionally) generated by bi-prediction (e.g., as shown in FIG. 17), for example, if (e.g., when) a merge candidate utilizes bi-directional prediction.

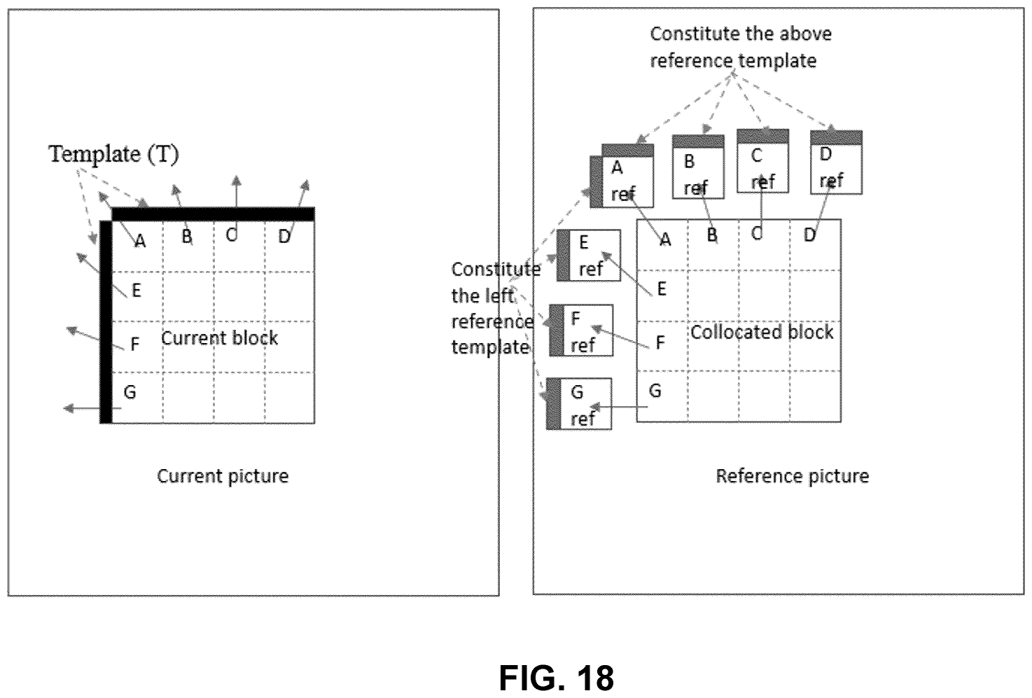

FIG. 18 illustrates example template and reference samples of the template for a block with sub-block motion using the motion information of the subblocks of the current block. The above template may comprise several sub-templates with the size of Wsub×1, and the left template may comprise several sub-templates with the size of 1×Hsub, for example, for subblock-based merge candidates with subblock size equal to Wsub×Hsub. As shown in FIG. 18, the motion information of the subblocks in the first row and the first column of current block may be used to derive the reference samples of each sub-template.

Bilateral matching AMVP-merge mode may be applied. The bi-directional predictor may include an AMVP predictor in a (e.g., one) direction and a merge predictor in the other direction. The mode can be enabled for a coding block, for example, if (e.g., when) the selected merge predictor and the AMVP predictor satisfy a DMVR condition (e.g., where there is at least one reference picture from the past and one reference picture from the future relative to the current picture and the distances from two reference pictures to the current picture are the same). The bilateral matching MV refinement may be applied for the merge MV candidate and AMVP MVP as a starting point. Template matching MV refinement may be applied to the merge predictor or the AMVP predictor (e.g., which has a higher template matching cost), for example, if template matching functionality is enabled.

The AMVP part of the mode may be signaled as a regular uni-directional AMVP (e.g., reference index and MVD are signaled). The AMVP part of the mode may have a derived MVP index, for example, if template matching is used or MVP index is signaled when template matching is disabled.

For AMVP direction LX, for example, X may be 0 or 1. The merge part in the other direction (1−LX) may be implicitly derived, for example, by minimizing the bilateral matching cost between the AMVP predictor and a merge predictor (e.g., for a pair of the AMVP and a merge motion vectors). The bilateral matching cost may be calculated using the merge candidate MV and the AMVP MV, for example, for every merge candidate in the merge candidate list which has that other direction (1−LX) motion vector. The merge candidate may be selected, for example, based on a cost (e.g., the merge candidate with the smallest cost may be selected). The bilateral matching refinement may be applied to the coding block with the selected merge candidate MV and the AMVP MV as a starting point.

The third pass of multi pass DMVR (e.g., which may be an 8×8 sub-PU BDOF refinement of the multi-pass DMVR) may be enabled for an AMVP-merge mode coded block.

The mode may be indicated by a flag. AMVP direction LX may be indicated by a flag (e.g., an additional flag) for example, if the mode is enabled.

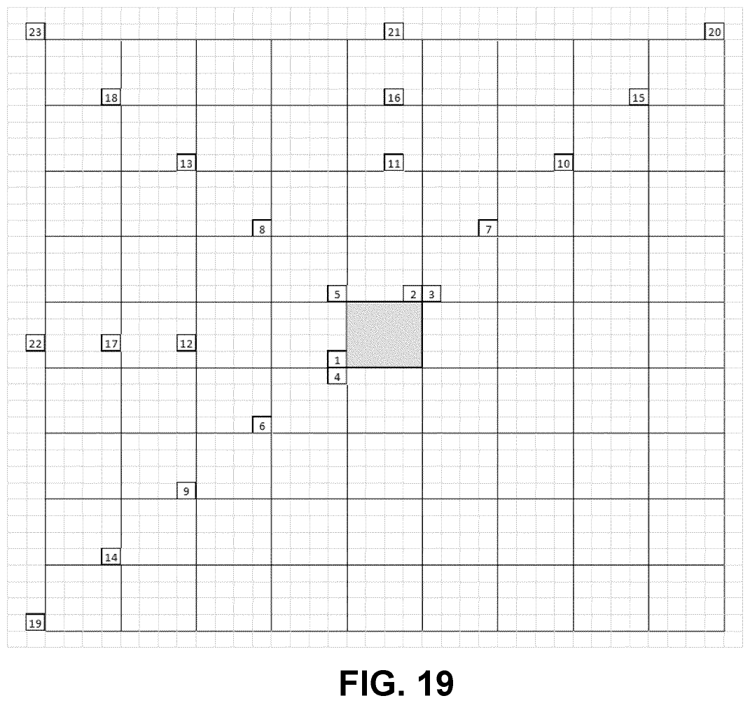

Non-adjacent spatial candidate(s) may be considered, inserted, and/or provided. The non-adjacent spatial merge candidates may be inserted (e.g., after the TMVP), for example, in the regular merge candidate list. FIG. 19 illustrates an example of spatial neighboring blocks used to derive the spatial merge candidates. The pattern of spatial merge candidates may be shown in FIG. 19. The distances between non-adjacent spatial candidates and current coding block may be based on the width and height of current coding block. The line buffer restriction may not be applied.

Symmetric MVD coding may be performed. Symmetric MVD mode (e.g., for bi-predictional MVD signaling) may be applied, for example, besides the normal unidirectional prediction and bi-directional prediction mode MVD signaling. Motion information (e.g., including reference picture indices of both list-0 and list-1 and MVD of list-1) may be derived (e.g., rather than signaled), for example, in the symmetric MVD mode.

The decoding process of the symmetric MVD mode may include one or more of the following. Variables BiDirPredFlag, RefldxSymL0 and RefldxSymL1 may be derived (e.g., at slice level), for example, based on one or more of the following: BiDirPredFlag may be set equal to 0, for example, if mvd_I1_zero_flag is 1; BiDirPredFlag is set to 1 and both list-0 and list-1 reference pictures are short-term reference pictures, for example, if the nearest reference picture in list-0 and the nearest reference picture in list-1 form a forward and backward pair of reference pictures or a backward and forward pair of reference pictures (e.g., otherwise BiDirPredFlag is set to 0).

A symmetrical mode flag indicating whether symmetrical mode is used or not may be signaled (e.g., explicitly signaled), for example, if the CU is bi-prediction coded and BiDirPredFlag is equal to 1 (e.g., at the CU level).

If (e.g., when) the symmetrical mode flag is true, (e.g., only) mvp_10_flag, mvp_11_flag and MVD0 may be signaled (e.g., explicitly signaled). The reference indices for list-0 and list-1 may be set equal to the pair of reference pictures, respectively. MVD1 may be set equal to (−MVD0). The final motion vectors may be shown in Eq. 9.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} + {mvdx}_{0} , {mvpy}_{1} + {mvdy}_{0} )\end{matrix} \qquad Eq . 9$$

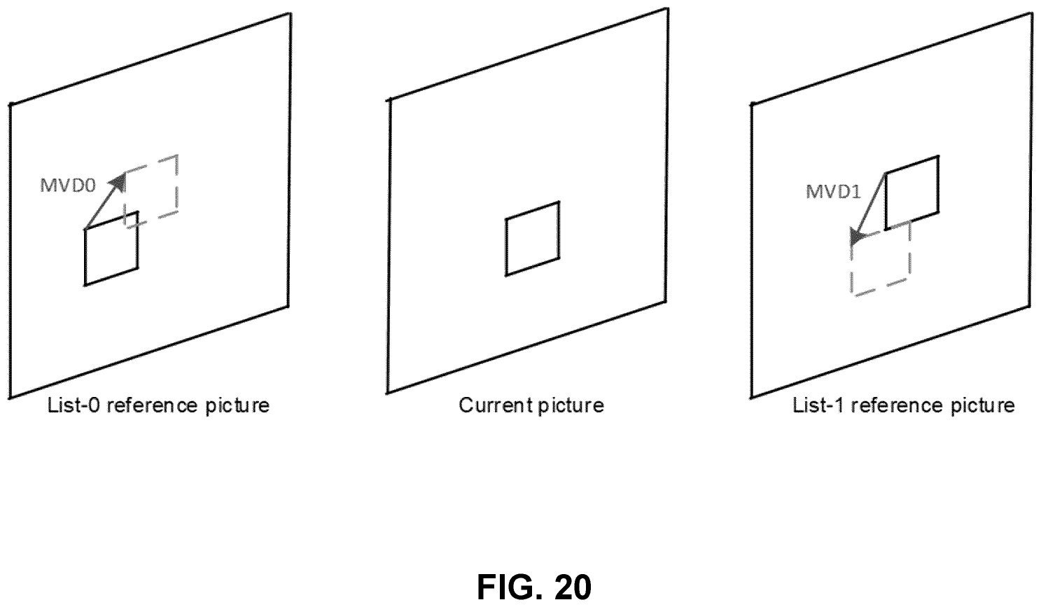

FIG. 20 illustrates an example symmetrical MVD mode. Symmetric MVD motion estimation may start with an MC evaluation (e.g., initial MV evaluation), for example, in the encoder. A set of initial MV candidates may include (e.g., comprise) the MV obtained from uni-prediction search, the MV obtained from bi-prediction search, and/or the MVs from the AMVP list. The MV candidate with the lowest rate-distortion cost may be chosen to be the initial MV for the symmetric MVD motion search.

Motion information candidates may be reordered using operations, for example, which may not depend on the reconstructed samples. The ordering (e.g., ranking) may be performed on a score computed from the motion information. The later stage of motion information refinement (e.g., at decoder side) may be used for reordering motion information candidates (e.g., refining the first order of motion information candidates).

Motion model extraction may be performed to obtain motion information associated with a current block for sorting the motion candidates. For a (e.g., each) block, a (e.g., one or more) motion model may be extracted, for example, for later comparisons with the motion information of the candidates. Motion model extraction may be performed, for example, to determine motion information associated with a block (e.g., sub-block).

A global motion model may be obtained. Global motion information may be sent, for example, at the slice level. A global motion model (e.g., at least one global motion model) may be computed (e.g., at encoder) and may be sent (e.g., in the slide header or picture header) in video data.

Operations associated with computing a global motion may include one or more of the following: performing a block matching between the reference frame and the current frame and extracting the dominant motion; extracting salient points (e.g., Harris corners or SIFT points) and matching them (e.g., robustly) according to a common motion model (e.g., using the RANSAC); etc.

The motion model can be an affine 4, affine 6, or homographic model, for example. A model (e.g., several models) can be transmitted. The model parameters can be sent as the motion of the corner of the frame, coded differentially, such as for example: top-left corner (e.g., sent as a motion vector using MVD encoding of the codec); top-right corner (e.g., send the MVD of the difference between the motion of the top-right and the motion of the top-left already decoded); bottom-left (e.g., same as top-right); bottom-right (e.g., MVD of the difference between the bottom-right motion and the average of the top-left and bottom-left motion vector); etc.

From the global motion model, the motion of the current block may be computed, for example using the motion of the center of the block. The top-left or other location can be used to compute the motion of the block.

An index of the global model to use may be signaled for the block using this mode, for example, if multiple (e.g., several) models are available. Context-based coding may use a neighboring block. A context-based coding using a neighboring block (e.g., top and left blocks) can be used to reduce the cost of signaling the index.

In examples, the collocated frame used as a reference frame for the motion vector may be signaled (e.g., in the slice header). The index of the global motion model may be signaled at block level, for example, in a similar or same way the reference frame index is signaled in inter coded blocks.

A local motion model may be obtained, derived, and/or provided. In examples, a motion model (e.g., one or several motion models) used later for a particular block may be extracted from the candidates.

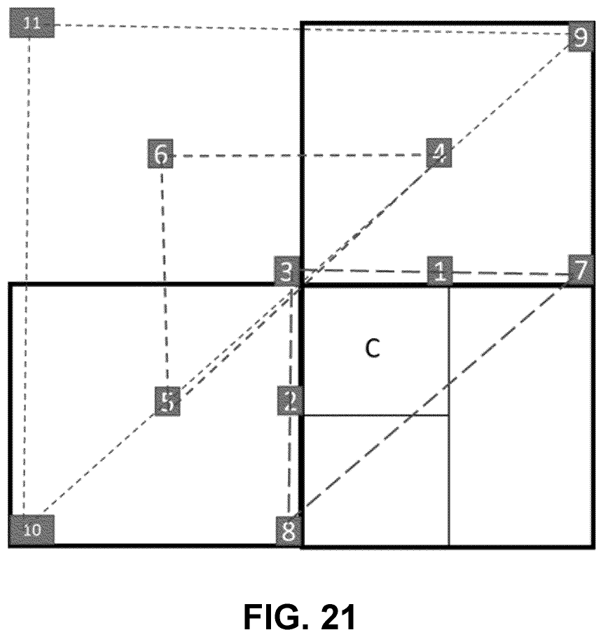

FIG. 21 illustrates an example local motion model computation. Candidates (e.g., several candidates) may be used to compute a local motion model. As shown, multiple (e.g., three) local models may be computed: Model A may be computed using the motion information in candidates 9, 10, 11; Model B may be computed using motion information in candidates 4, 5, 6; and/or Model C may be computed using motion information in candidates 8, 3 and 7.

The computation of the local motion model can be performed, for example, using a same or similar process as the affine inherited candidate's construction (e.g., as described herein).

A global temporal motion vector buffer may be used to obtain the motion model. A motion model (e.g., full motion model) may be created on the current frame, for example, using past motion information and creating a buffer filled with a motion vectors predictor.

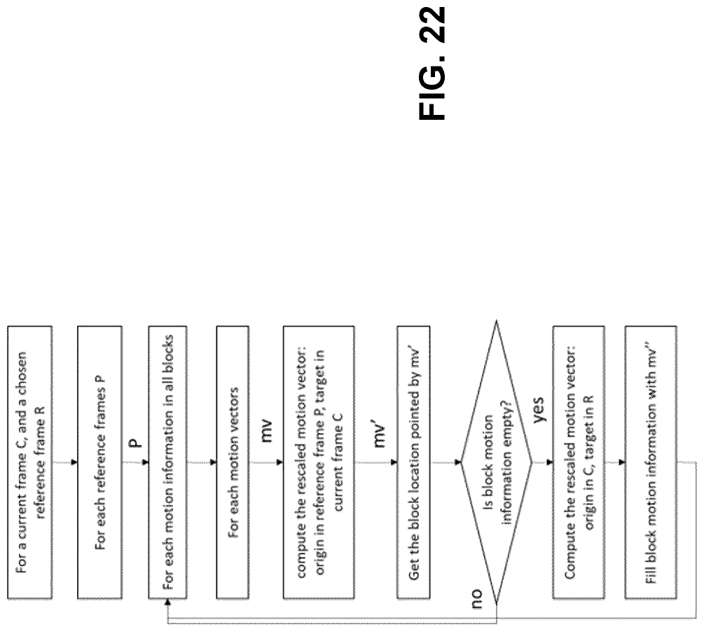

FIG. 22 illustrates an example temporal buffer construction. A buffer of temporal motion information candidates may be constructed, for example, as shown in FIG. 22. An empty buffer may be created, for example, before decoding the current frame C. Motion information may be (e.g., assumed to be) computed using the reference frame R. The reference frame R may be the (e.g., first) reference frame corresponding to the (e.g., first) index in the reference frame list. In case of multiple reference frame candidates, several buffers may be built the same way. The motion information may be used to compute motion information for the current frame, for example, for a (e.g., each) reference frame P in the reference picture buffer list. For block(s) of frame P, a rescaled motion vector may be computed (e.g., using a same or similar process as the one used to construct a temporal motion vector predictor), for example, if it contains motion information. The rescaled motion vector may allow for computing the block to fill in the buffer. A rescaled motion vector using the reference frame R and origin frame C may be computed and stored in the block, for example, if the block does not already have a motion information.

Reference frame P may be selected. In examples, the frame with a picture order count (POC) closest to the current frame may be examined (e.g., first). Order may be determined based on the temporal distance between the reference frame and the current frame.

Motion information for a (e.g., each) block may be selected. In examples, symmetrical candidates may be selected based on POC distance (e.g., as described herein). Symmetrical candidates may be considered, applied, selected, and/or provided. For example, a symmetrical version of the TMVP vector may be added. For example, the temporal motion vector may be replaced by a symmetrical version of the TMVP vector (e.g., if/when possible).

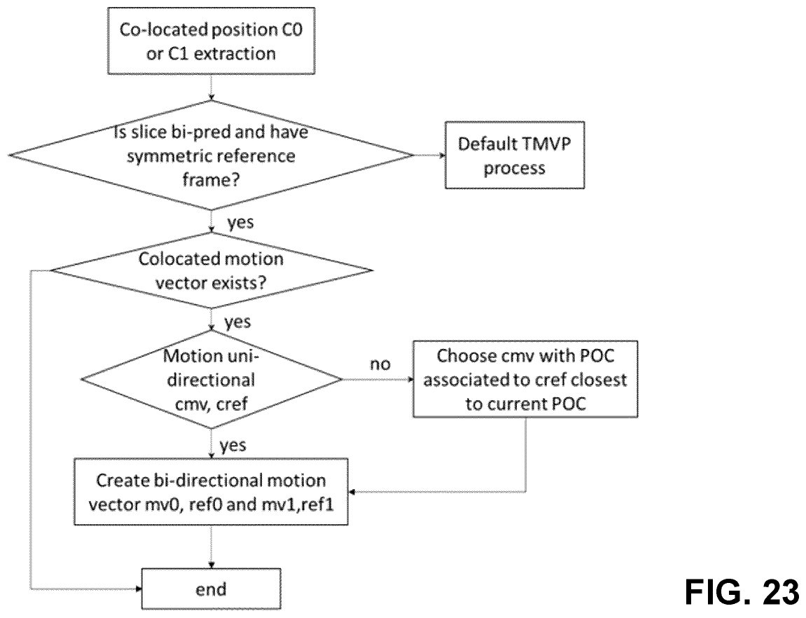

FIG. 23 illustrates an example symmetrical temporal candidate process. The process to extract the symmetrical temporal motion vector candidate may be performed. The position for co-located motion may be extracted (e.g., as in the default temporal motion process), for example, by testing if the bottom-right outside the CU is valid, and if not, testing if the center position is valid. Other positions (e.g., additionally or alternatively) can be tested. The symmetrical motion candidate process may be used, for example, if the current slice is a bi-prediction slice and symmetrical reference frame exist in L0 and L1 reference list (e.g., otherwise the default motion temporal process is used). The symmetrical reference pictures may be called ref0 and ref1. The symmetrical reference pictures may be symmetrically in the past and the future of the current frame (e.g., same or similar way as in the symmetric MVD coding process). The collocated motion may be used as the motion to rescale, for example, if the collocated motion is uni-directional. The motion cmv may be referred to as cref, for example, denoting the motion vector and the reference picture index associated. If the collocated motion vector is bi-prediction: cPOC may refer to the POC of the current frame; cPOC0 may refer to the POC of the reference frame corresponding to the reference index in list L0 of the collocated motion vector; cPOC1 may refer to the POC of the reference frame corresponding to the reference index in list L1 of the collocated motion vector. The motion of list 0 may be selected for rescaling, for example, if abs(cPOC-cPOC0)<abs(cPOC-cPOC1) (e.g., otherwise the one of the list 1 may be selected). The selected motion may be rescaled to point to the reference frame ref0 in list L0 and reference frame ref1 in list L1, for example, using the (e.g., default) temporal motion rescaling process.

Motion consistency-based re-ordering may be applied, performed, and/or provided. For example, motion information candidates may be ordered based on comparing the motion information candidates with motion information associated with the current coding block. The motion information may include a motion model.

The consistency with a motion model (e.g., as described herein) may be used to compute a cost for a (e.g., each) candidate (for example, instead of using a template and reference samples to compute the cost for the candidate). For example, a device (e.g., decoding device or encoding device) may obtain an indication (e.g., signal) that indicates whether a template-based coding tool is enabled for a coding block (e.g., subblock). Ordering the motion information candidates based on comparing the motion information candidates to motion information based on consistency may be performed, for example, if the device determines that the template-based coding tool is disabled. The operation may refrain from performing (e.g., not perform, not require) the reconstruction of neighboring blocks to decode the motion information of the current block.

The motion information (e.g., motion model, motion vector differences) associated with the current block may be taken from one or more of the following: one or more global motion models (e.g., indicated in video data, transmitted to the decoder) as described herein; one or more local motion model computed (e.g., at the decoder) from (e.g., already decoded) motion information; the global temporal motion information buffer as described herein. The motion information associated with the block for re-ordering motion candidates may include the motion information collocated in the temporal buffer.

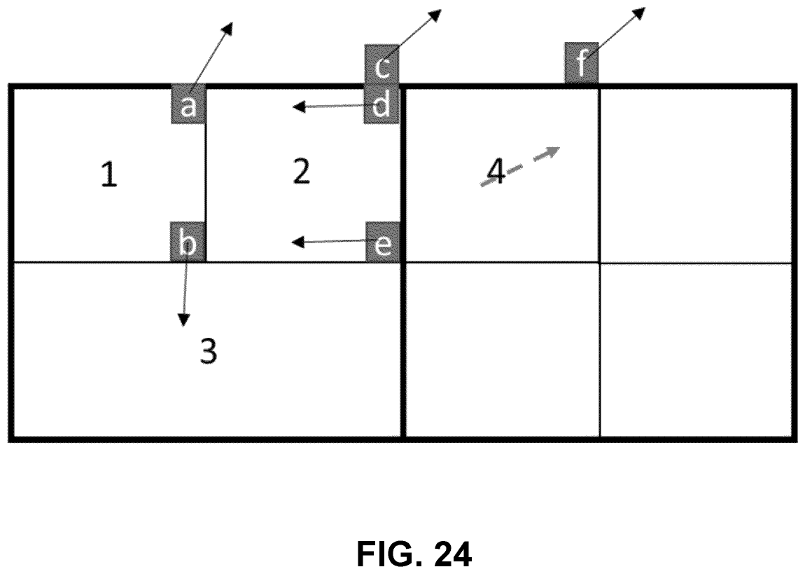

Motion candidate consistency scores may be computed for the motion candidates for the block. FIG. 24 shows an example of a motion vector candidate and global motion field (e.g., when decoding the block 4): candidates c,f,d,e may be spatial motion candidates in the plain dark line; candidates a and b may be non-adjacent candidates in the plain dark line; and/or the motion vector in gray dash may be the one deduced from the global motion model. The motion vector may be computed by applying the motion model at the block center. In examples, the location may be chosen at a corner of the block (e.g., the top-left corner).

Table 2 shows the original motion vector candidate's order:

TABLE 2

| index | candidate |
|---|---|
| 0 | f |
| 1 | e |
| 2 | d |
| 3 | c |
| 4 | a |
| 5 | b |

From the candidate vectors and a global model vector, a score can be computed for a (e.g., each) motion vector candidate, for example, as shown in Table 3.

TABLE 3
Score Table

| Candidate | score |
|---|---|
| a | 2 |
| b | 40 |
| c | 3 |
| d | 30 |
| e | 45 |
| f | 5 |

The score of each candidate may be computed as the difference between the candidate motion vector and the global motion vector, for example, using a L1 norm: score=|mv_x−g_x|+|mv_y−g_y|. An L2 norm can (e.g., alternatively) be used. For example, the score may indicate a consistency value. The consistency value for a first motion information candidate may be determined based on the motion information associated with the block (e.g., global motion model, local motion model, the motion information collocated in the temporal buffer).

The device may indicate an index associated with the candidate and the computed score. The index may indicate the order of the candidates.

The rescaling process of a temporal motion vector predictor (TMVP) may be applied, for example, to compare a motion vector pointing to different reference frames. For example, motion vectors may be rescaled to point on the first reference frame (e.g., index 0) for a (e.g., each) list. Temporal motion vector candidate can be checked (e.g., in the same or similar way as described herein).

In examples, the reordering may be performed based on the motion vector difference. The candidates may be ranked from the lowest to the highest score (e.g., the motion information candidate with a lower score may be associated with a higher consistency to the motion information (e.g., global motion model, local motion model)), for example, as shown in Table 4.

TABLE 4

| Candidate | score | rank |
|---|---|---|
| a | 2 | 0 |
| b | 40 | 4 |
| c | 3 | 1 |
| d | 30 | 3 |
| e | 45 | 5 |
| f | 5 | 2 |

Partial reordering may be performed. In examples, the reordering may be partial. In examples, the N candidates (e.g., only the first N candidates) may be reordered. In examples, candidates may be re-ordered by group. For example, N candidates (e.g., the N first candidates) may be reordered, and then the M candidates following may be reordered together.

A global motion compensation (GMC) candidate may be determined and/or provided. For example, there may be multiple spatial candidates (e.g., candidate f,c,e in FIG. 24) that may have a score below a given threshold. The candidates may be replaced by the motion model generated motion vector (e.g., at the block center).

In examples, multiple motion models may be used (e.g., either global motion models or local ones). In this case, the score may be computed by taking the lowest score of a candidate across the models (e.g., all models), for example, except for local models when the candidate was used to compute the model (e.g., because the score would be 0).

An affine mode may be applied and/or provided. In examples, the current block may use a sub-block mode, for example, such as an affine mode. In examples, the score may be computed as the average of the differences between the control point of the model (CPMV) and the motion vector inferred at the CPMV location (e.g., using the motion model).

A subblock-based mode may be applied and/or provided. In examples, the current block may use a sub-block mode, for example, such as SbTMVP mode. In this case, the score may be computed as the average of the difference between the motion vector of a (e.g., each) sub-block and the motion from the motion model.

Re-ordering with a motion refinement step may be performed. Re-ordering with a motion refinement step may be performed, for example, using the determined order (e.g., the order determined based on consistency to motion information). The re-ordering may generate a second order of motion information candidates. The second order of motion information candidates may be a refinement of the first order of motion information candidates. The decoding and/or encoding device may be indicated to perform a re-ordering with motion refinement.

Constraints on re-ordering may be applied. Constraints on the re-ordering may be applied, for example, in case the mode uses a motion refinement step (e.g., TM or DMVR). Candidates close together may be likely to end up to the same final motion vector after refinement.

The motion model (e.g., local motion model, global motion model) can be used to check if multiple motion vector candidates are close or not. In examples, the motion vector candidate (e.g., only the first motion vector candidate) consistent with a given motion model in the original list order may be kept.

For example, given the score table in table 3 and a threshold (e.g., which may be indicated) of six to consider that a motion vector is consistent with the given motion model, the following ranking may be obtained (e.g., as shown in Table 5).

TABLE 5

| Candidate | score | rank |
|---|---|---|
| a | 2 | 0 |
| b | 40 | 2 |
| c | 3 | Removed |
| d | 30 | 1 |
| e | 45 | 3 |
| f | 5 | Removed |

As shown, candidate c and f may be removed, for example, because their scores are below the threshold, and candidate a, upper in the list, may have already been kept. For example, candidates with scores below the threshold may be too similar (e.g., not varied enough) to a first candidate. In examples, the discarded candidates may be put at the end of the list.

One or more global motion model may be signaled (e.g., in video data, in bitstream). For example, signaling may be performed at the slice level.

Global motion model parameters may be transmitted. The global motion model parameters are also transmitted (e.g., at the slice/picture/sequence level), for example, if (e.g., when) a (e.g., at least one) global motion model is used. The global motion model parameters may be transmitted, for example, using the syntax as shown in Table 6.

TABLE 6

| | |
|---|---|
| sh_global_motion_enabled_flag | ae(v) |
| if (sh_global_motion_enabled_flag) { | |
| model_order | ae(v) |
| mvd_coding( cpmv_top_left ) | |
| if( model_order>1 ) | |
| mvd_coding( cpmv_top_right-cpmv_top_left ) | |
| if(model_order>2) | |
| mvd_coding( cpmv_bottom_left-cpmv_top_left ) | |
| if(model_order>3) | |
| mvd_coding( cpmv_bottom_right-(cpmv_top_right+cpmv_bottom_left)/2) | |

model_order may be an integer between 0 and 3, for example, to control the order of the motion model (e.g., translational, affine 4, affine 6 or homographic).

In examples, the cpmv may be coded differentially, for example, by predicting a (e.g., each) corner using the already available corners and the associated model.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-46. (canceled)

47. A video decoding device, comprising:
a processor configured to:
obtain a plurality of motion information candidates associated with a block;
determine motion information associated with the block;
determine an order associated with the plurality of motion information candidates based on comparing the respective motion information candidates with the determined motion information, wherein a higher rank is associated with a higher consistency associated with a motion model; and
decode the block based on the determined order associated with the plurality of motion information candidates.

48. The video decoding device of claim 47, wherein the order associated with the plurality of motion information candidates is associated with a ranking of the plurality of motion information candidates, wherein the order associated with the plurality of motion information candidates is ordered from a higher rank to a lower rank.

49. The video decoding device of claim 47, wherein the processor is further configured to:
obtain an indication that indicates whether a template-based coding tool is enabled for the block, wherein the determination of the order associated with the plurality of motion information candidates is performed based on the indication indicating that the template-based coding tool is not enabled for the block and is performed independent from reconstructed samples.

50. The video decoding device of claim 47, wherein the motion model is a global motion model, and wherein the processor is further configured to:
obtain global motion information associated with a slice that comprises the block, wherein the motion information associated with the block comprises the global motion information associated with the slice, wherein the global motion information is associated with the global motion model, wherein the order associated with the plurality of motion information candidates is further determined based on comparing the respective motion information candidates with the global motion information associated with the slice, and wherein the global motion information associated with the slice is obtained via a slice header.

51. The video decoding device of claim 47, wherein the motion model is a local motion model, and wherein the processor is further configured to:
derive local motion information associated with the local motion model based on motion information candidates associated with neighboring blocks of the block, wherein the motion information associated with the block comprises the derived local motion information.

52. The video decoding device of claim 47, wherein determining the order associated with the plurality of motion information candidates further comprises:
determining, for a first motion information candidate of the plurality of motion information candidates, a first consistency value relative to the obtained motion information;
determining, for a second motion information candidate of the plurality of motion information candidates, a second consistency value relative to the obtained motion information; and
based on the first motion information candidate being associated with higher consistency value than the second motion information candidate, ranking the first motion information candidate higher than the second motion information candidate.

53. The video decoding device of claim 47, wherein determining the order associated with the plurality of motion information candidates further comprises:
determining, for a first motion information candidate of the plurality of motion information candidates, a first consistency value relative to the obtained motion information;
determining, for a second motion information candidate of the plurality of motion information candidates, a second consistency value relative to the obtained motion information; and
based on the first motion information candidate being associated with higher consistency value than the second motion information candidate, ranking the first motion information candidate lower than the second motion information candidate.

54. The video decoding device of claim 47, wherein determining the order associated with the plurality of motion information candidates further comprises:
obtaining a difference between a first motion information candidate and a second motion information candidate of the plurality of motion information candidates; and
based on a difference between the first motion information candidate and the second motion information candidate is below a threshold, removing the second motion information candidate.

55. A video encoding device, comprising:
a processor configured to:
obtain a plurality of motion information candidates associated with a block;
obtain motion information associated with the block;
determine an order associated with the plurality of motion information candidates based on comparing the respective motion information candidates with the obtained motion information, wherein a higher rank is associated with a higher consistency associated with a motion model; and
encode the block based on the determined order associated with the plurality of motion information candidates.

56. The video encoding device of claim 55, wherein the processor is further configured to:
determine whether to perform motion information-based candidate ordering; and
based on a determination to perform motion information-based candidate ordering for the block, include an indication that indicates to enable motion information-based candidate ordering, wherein the indication further indicates to decode the encoded block based on motion information associated with neighboring blocks of the block.

57. The video encoding device of claim 56, wherein the motion model is a global motion model, wherein the motion information for the block comprises global motion information, and wherein the processor is further configured to:
compute global motion information associated with a slice that comprises the block, wherein the motion information for the block comprises the computed global motion; and
include an indication of the global motion information in video data, wherein the global motion information is associated with the global motion model, wherein the indication further indicates to derive global motion information based on rescaling temporal motion information candidates associated with a temporal reference frame, and wherein the indication further indicates to rescale based on temporal distance.

58. The video encoding device of claim 56, wherein the motion model is a local motion model, wherein the motion information for the block is local motion information, and wherein the indication further indicates to derive the local motion information based on motion information candidates associated with neighboring blocks, wherein the local motion information is associated with the local motion model.

59. The video encoding device of claim 56, wherein the indication further indicates to determine a respective consistency value associated with each of the motion information candidates and the neighboring blocks, and wherein the indication further indicates to determine the order of motion information candidates based on the consistency values, wherein a higher consistency value is ranked higher than a lower consistency value.

60. The video encoding device of claim 56, wherein the indication further indicates to determine a first order of motion information candidates and a second order of motion information candidates, wherein the indication further indicates to determine the second order of motion information candidates based on the first order of motion information candidates and a threshold, and wherein the second order of motion information candidates is a refinement of the first order of motion information candidates.

61. The video encoding device of claim 55, wherein the processor is further configured to:
select a motion predictor for the block from the plurality of motion information candidates;
determine an index for selected motion predictor based on the order associated with the plurality of motion information candidates; and
include an indication that indicates the index in video data.

62. A video encoding method, comprising:
obtaining a plurality of motion information candidates associated with a block;
obtaining motion information associated with the block;
determining an order associated with the plurality of motion information candidates based on comparing the respective motion information candidates with the obtained motion information, wherein a higher rank is associated with a higher consistency associated with a motion model; and
encoding the block based on the determined order associated with the plurality of motion information candidates.

63. The video encoding method of claim 62, wherein the method further comprises:
determining whether to perform motion information-based candidate ordering; and
based on a determination to perform motion information-based candidate ordering for the block, including an indication that indicates to enable motion information-based candidate ordering, wherein the indication further indicates to decode the encoded block based on motion information associated with neighboring blocks of the block.

64. The video encoding method of claim 63, wherein the motion model is a global motion model, wherein the motion information for the block comprises global motion information, and wherein the method further comprises:
computing global motion information associated with a slice that comprises the block, wherein the motion information for the block comprises the computed global motion; and
including an indication of the global motion information in video data, wherein the global motion information is associated with the global motion model, wherein the indication further indicates to derive global motion information based on rescaling temporal motion information candidates associated with a temporal reference frame, and wherein the indication further indicates to rescale based on temporal distance.

65. The video encoding method of claim 63, wherein the motion model is a local motion model, wherein the motion information for the block is local motion information, and wherein the indication further indicates to derive the local motion information based on motion information candidates associated with neighboring blocks, wherein the local motion information is associated with the local motion model.

66. The video encoding method of claim 63, wherein the indication further indicates to determine a respective consistency value associated with each of the motion information candidates and the neighboring blocks, and wherein the indication further indicates to determine the order of motion information candidates based on the consistency values, wherein a higher consistency value is ranked higher than a lower consistency value.
